(19) United States
(12) Patent Application Publication
(10) Pub. No.: US 2017/0284611 A1
(43) Pub. Date: Oct. 5, 2017

(54) PROJECTION LIGHT SOURCE STRUCTURE WITH BAT-WING CANDLE POWER DISTRIBUTION

(71) Applicant: AREX(TWN) INTERNATIONAL CO., LTD., New Taipei City (TW)

(72) Inventors: Yuh-sheng LIN, New Taipei City (TW); Che-Chun CHANG, New Taipei City (TW); Chin-hung LIN, Keelung City (TW)

(21) Appl. No.: 15/472,296

(22) Filed: Mar. 29, 2017

(30) Foreign Application Priority Data
Apr. 1, 2016 (TW) 105204627

(51) Int. Cl. F21K 9/69; F21K 9/68; F21V 7/04; F21V 13/04; F21V 5/02; F21V 5/00

(52) U.S. Cl. CPC F21K 9/69; F21V 5/02; F21V 5/004; F21V 7/04; F21V 13/04; F21V 5/008; F21K 9/68; F21Y 2115/15

(57) ABSTRACT

A projection light source structure having the bat-wing candle power distribution is described. The projection light source structure includes a light-emitting diode, a prism sheet and/or a reflection structure. The light source is adjusted by a prism sheet and/or a diffuser assembly to control the LED light source to form a bat-wing candle power distributions with a uniform emitting light, and by the reflection structure so that the emitting light to form a predetermined shape of the illuminance area.

### BACKGROUND OF THE INVENTION

### Field of Invention

The present invention relates to a technical field of a lamp, and more particularly to a projection light source structure with a bat-wing candle power distribution.

### Description of Prior Art

Currently, with a rapid development stage of a lamp technology with a light-emitted diode (LED), it has been gradually replaces the conventional lamp. The major difference of the LED lamp and the lamp tube type is that the LED light source of the lamp is emitted by an LED chip, which is a point light source. Due to the characteristics of the LED point light source in the LED lamp design, how the light sources are reflected, so that the point light source can radiate into uniform light, becomes one of LED lamp design issues.

Conventional lamp is circular distribution of light emitting illuminance region, and the illuminance area is located directly below the lamp to form a peak illuminance in an uneven state. For example, as the lamp is gradually increased from the desktop, the lamp illuminance is inversely proportional to the square of the distance to form a non-uniform illuminance distribution, and it is not easy to control a shape and a region size of the illuminance region. Accordingly, there is a need to develop a new lamp to solve the aforementioned problem of non-uniform distribution of light.

### SUMMARY OF THE INVENTION

Therefore, one objective of the present invention is to provide a projection light source structure having the bat-wing candle power distribution. The projection light source structure includes a light-emitting diode, a prism sheet and/or a diffuser assembly, The light source is adjusted by a prism sheet and/or a diffuser assembly to control the LED light source to form a bat-wing candle power distribution with a uniform emitting light, and by the reflection structure so that the emitting light to form a predetermined shape of the illuminance area.

Based on the above objective, the present invention sets forth the following technical solutions. The present invention provides a projection light source structure having a bat-wing candle power distribution, comprising at least one light-emitting diode (LED) light source disposed on a substrate to form a light; and a prism sheet having a first light incident surface and a first light emitting surface opposite to the first light incident surface, wherein the first light incident surface is directed to the at least one light-emitting diode light source, a plurality of prismatic structures is distributed on the first light incident surface to guide the light for projecting the light from the first light incident surface to the first light emitting surface to form the bat-wing candle power distribution having an emitting light.

In one embodiment, the at least one LED light source comprises either an organic light-emitting diode (©LED) or a polymer light-emitting diodes (PLED).

In one embodiment, the at least one LED light source comprises a plurality of LED light sources.

In one embodiment, the first light emitting surface of the prism sheet is a planar structure.

In one embodiment, a material of the prism sheet is selected from one group consisting of poly ethylene terephthalate (PET), polyurethane (PU), polycarbonate (PC), polypropylene (PP), polymethyl methacrylate (PMMA), glass and silicon material.

In one embodiment, the projection light source structure having the bat-wing candle power distribution further comprises a diffuser assembly adjacent to the prism sheet, wherein the prism sheet is disposed between the at least one LED light source and the diffuser assembly to diffuse the emitting light of the bat-wing candle power distributions to form a uniform emitting light.

In one embodiment, the diffuser assembly comprises a second light incident surface and a second light emitting surface opposite to the second light incident surface, and the second light incident surface is configured to receive the emitting light and the second emitting light surface emits the received emitting light.

In one embodiment, the diffuser assembly is either a diffusion sheet or a diffusion plate.

In one embodiment, the second light emitting surface of the diffuser assembly comprises a plurality of micro-lens structures.

In one embodiment, each of the micro-lens structures is selected from one group consisting of a micro convex lens structure, a micro concave lens structure, and the combination.

In one embodiment, the projection light source structure having the bat-wing candle power distribution further comprises a reflection structure, wherein the reflection structure is disposed in a peripheral region of the at least one light-emitting diode light source and the prism sheet, so that the emitting light to form a predetermined shape of an illuminance area.

In one embodiment, a shape of the reflection structure is selected from one group consisting of a square shape, a rectangular shape, an oval shape, a polygon shape, and an irregular shape.

In one embodiment, length-to-width ratio of the rectangular shape is selected from one group consisting of 2:1, 4:3 and 16:9.

In another embodiment, the present invention provides a projection light source structure having a bat-wing candle power distribution, comprising at least one light-emitting diode (LED) light source disposed on a substrate to form a light; a prism sheet having a first light incident surface and a first light emitting surface opposite to the first light incident surface, wherein the first light incident surface is directed to the at least one light-emitting diode light source, a plurality of prismatic structures is distributed on the first light incident surface to guide the light for projecting the light from the first light incident surface to the first light emitting surface to form the bat-wing candle power distribution having an emitting light; and a diffuser assembly adjacent to the prism sheet, wherein the prism sheet is disposed between the at least one LED light source and the diffuser assembly to diffuse the emitting light of the bat-wing candle power distributions to form a uniform emitting light.

In one embodiment, the at least one LED light source comprises either an organic light-emitting diode (OLED) or a polymer light-emitting diodes (PLED).

In one embodiment, the at least one LED light source comprises a plurality of LED light sources.

In one embodiment, the first light emitting surface of the prism sheet is a planar structure.

In one embodiment, a material of the prism sheet is selected from one group consisting of poly ethylene terephthalate (PET), polyurethane (PU), polycarbonate (PC), polypropylene (PP), polymethyl methacrylate (PMMA), glass and silicon material.

In one embodiment, the diffuser assembly comprises a second light incident surface and a second light emitting surface opposite to the second light incident surface, and the second light incident surface is configured to receive the emitting light and the second emitting light surface emits the received emitting light.

In one embodiment, the diffuser assembly is either a diffusion sheet or a diffusion plate.

In one embodiment, the second light emitting surface of the diffuser assembly comprises a plurality of micro-lens structures.

In one embodiment, each of the micro-lens structures is selected from one group consisting of a micro convex lens structure, a micro concave lens structure, and the combination.

In one embodiment, the projection light source structure having the bat-wing candle power distribution further comprises a reflection structure, wherein the reflection structure is disposed in a peripheral region of the at least one light-emitting diode light source and the prism sheet, so that the emitting light to form a predetermined shape of an illuminance area.

In one embodiment, a shape of the reflection structure is selected from one group consisting of a square shape, a rectangular shape, an oval shape, a polygon shape, and an irregular shape.

In one embodiment, a length-to-width ratio of the rectangular shape is selected from one group consisting of 2:1, 4:3 and 1.6:9.

### BRIEF DESCRIPTION OF THE DRAWINGS

The following embodiments refer to the accompanying drawings for exemplifying specific implementable embodiments of the present invention.

FIG. 1 is an illustrative three-dimensional view of a projection light source structure having a bat-wing candle power distribution according to a first embodiment of the present invention;

FIG. 2 is an illustrative waveform view of the bat-wing candle power distribution in FIG. 1 according to the first embodiment of the present invention;

FIG. 3 is an illustrative illuminance view of the projection light source structure according to the first embodiment of the present invention;

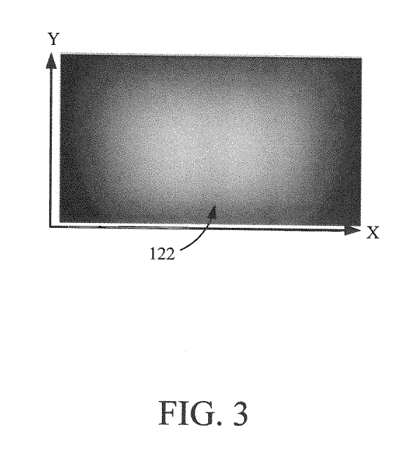

FIG. 4 is an illustrative three-dimensional view of a projection light source structure having a bat-wing candle power distribution according to a second embodiment of the present invention;

FIG. 5 is an illustrative waveform view of the bat-wing candle power distribution in FIG. 4 according to the second embodiment of the present invention;

FIG. 6 is an illustrative three-dimensional view of a projection light source structure having a bat-wing candle power distribution according to a third embodiment of the present invention;

FIG. 7 is an illustrative three-dimensional view of a projection light source structure having a bat-wing candle power distribution according to a fourth embodiment of the present invention; and

FIG. 8 is an illustrative waveform view of the bat-wing candle power distribution in PG 7 according to the fourth embodiment of the present invention.

### DETAILED DESCRIPTION OF THE PREFERRED EMBODIMENTS

The following embodiments refer to the accompanying drawings for exemplifying specific implementable embodiments of the present invention. Furthermore, directional terms described by the present invention, such as upper, lower, front, back, left, right, inner, outer, side, etc., are only directions by referring to the accompanying drawings, and thus the used directional terms are used to describe and understand the present invention, but the present invention is not limited thereto. In the drawings, the same reference symbol represents the same or a similar component.

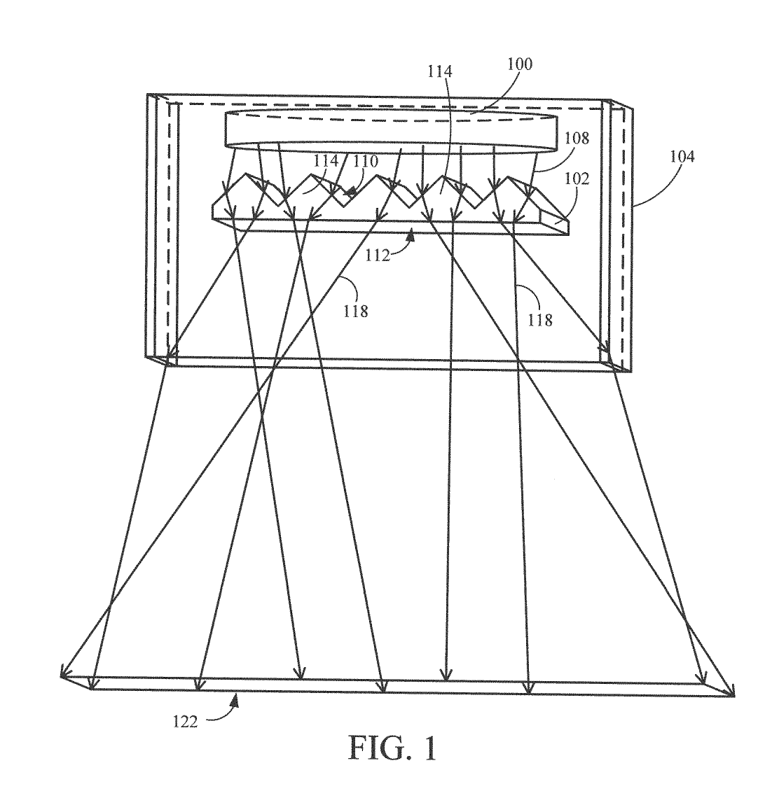

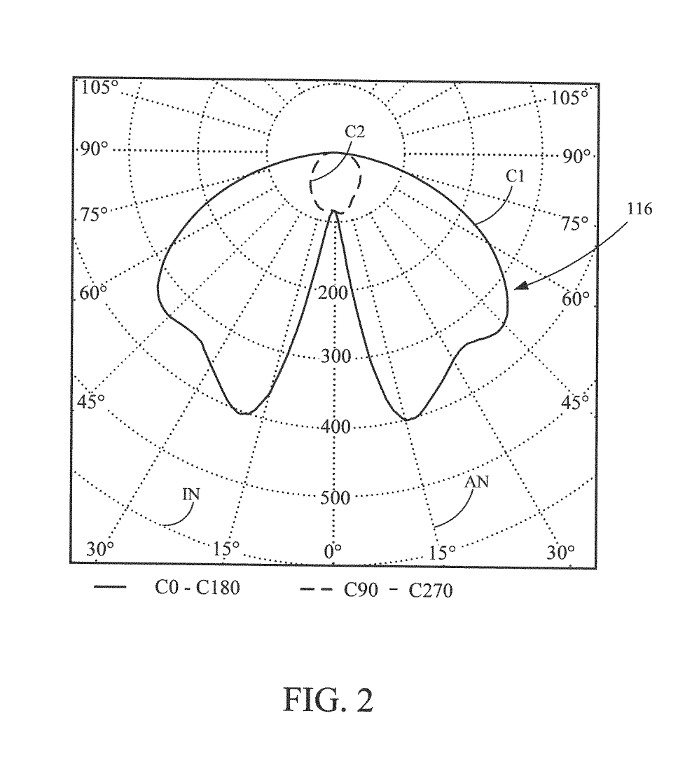

FIG. 1 is an illustrative three-dimensional view of a projection light source structure having a bat-wing candle power distribution according to a first embodiment of the present invention. FIG. 2 is an illustrative waveform view of the bat-wing candle power distribution in FIG. 1 according to first embodiment of the present invention. The projection light source structure having a bat-wing candle power distribution includes at least one light-emitting diode light source 100, a prism sheet 102 and a reflection structure 104. The at least one LED light source 100 is disposed on a substrate (not shown) to form a light 108. The at least one LED light source includes an organic light-emitting diode (OLED) and a polymer light-emitting diodes (PLED). The at least one LED light source 100 includes one or more light-emitting diode light sources 100. In this case, one LED light source 100 is depicted. In another embodiment, the projection light source structure having a bat-wing candle power distribution includes at least one light-emitting diode light source 100 and a prism sheet 102, to save the manufacturing cost of the projection light source structure by omitting the reflection structure 104.

As shown in FIG. 1, the prism sheet 102 has a first light incident surface 110 and a first light emitting surface 112 is opposite to the first light incident surface 110, where the first light incident surface 110 is directed to the at least one light-emitting diode light source 100, a plurality of prismatic structures 114 is distributed on the first light incident surface 110 to guide the light 108 for projecting the light 108 from the first light incident surface 110 to the first light emitting surface 112 to form the bat-wing candle power distribution 116 having an emitting light 118. The prism sheet 102 refract the light 108 to be illuminate in the left side and the right side by using the first light incident surface 110 of the prismatic structures 114 to form the bat-wing candle power distribution 116. The first light emitting surface 112 of the prism sheet 102 is a planar structure. In one embodiment, the material of the prism sheet 102 is selected from one group consisting of poly ethylene terephthalate (PET), polyurethane (PU), polycarbonate (PC), polypropylene (PP), polymethyl methacrylate (PMMA), glass and silicon material. In one embodiment, the first light incident surface 110 and the first light emitting surface 112 of the prism sheet 102 is a transparent surface.

As shown in FIG. 1, the reflection structure 104 is disposed in the peripheral region of the at least one light-emitting diode light source 100 and the prism sheet 102, so that the emitting light 118 to form a predetermined shape of the illuminance area 122. In other words, the reflection structure 104 surrounds the LED light source 100 and the prism sheet 102 around the peripheral region. The shape of the reflection structure 104 is selected from one group consisting of a square, a rectangular, an oval, a polygon and an irregular shape. The length-to-width ratio of the rectangular shape is selected from one group consisting of 2:1, 4:3 and 16:9, but it can also be different ratio of sizes.

As shown in the candle power distribution C1 of FIG. 2, an emitting angle “AN” at 0 degrees to 75 degrees have a wide range of luminous intensity (light intensity IN) along 0 to 180 degrees (C0-C180) of the symmetrical bat-wing candle power distribution C1 to form a rectangular illuminance area 122. In other words, the candle power distribution C1 forms a light shape of a bat-wing candle power distribution so that the light is concentrated in the lower left position and the lower right position of the prism sheet 102 to form the rectangular illuminance area 122. In FIG. 2, a candle power distribution C2 is a candle power distribution along 90 degrees to 270 degrees (C90-C270). In the bat-wing candle power distribution of the present invention, the emitting light 118 within the illuminance area 122 of the reflection structure 104 forms a uniform illuminance distribution.

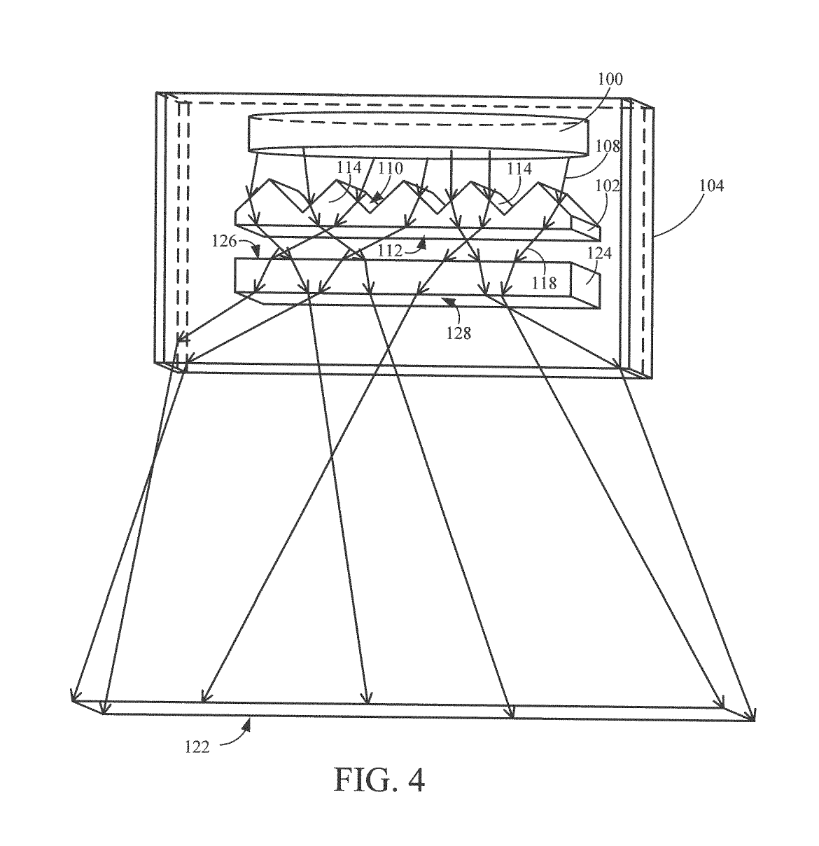

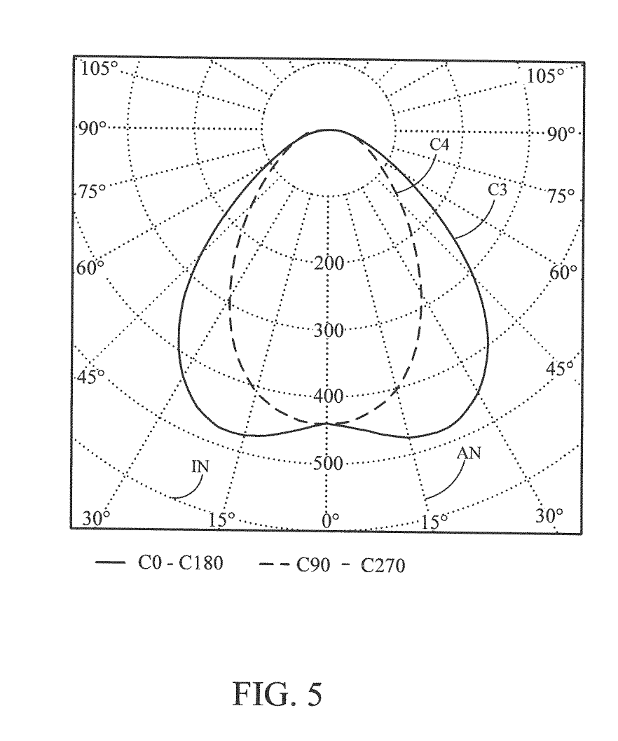

FIG. 4 is an illustrative three-dimensional view of a projection light source structure having a bat-wing candle power distribution according to a second embodiment of the present invention. FIG. 5 is an illustrative waveform view of the bat-wing candle power distribution in FIG. 4 according to the second embodiment of the present invention. The candle power distribution with the bat-wing candle power distribution of a projection light source structure in the second embodiment is similar to the candle power distribution with the bat-wing candle power distribution of a projection light source structure in the first embodiment. The difference is that the projection light source structure in the second embodiment further includes a diffuser assembly 124 adjacent to the prism sheet 102. The prism sheet 102 is disposed between the at least one LED light source 100 and the diffuser assembly 124 to diffuse the emitting light 118 of the bat-wing candle power distributions to form a uniform emitting light. The diffuser assembly 124 includes a second light incident surface 126 and the second light emitting surface 128 opposite to the second light incident surface 126, where the second light incident surface 126 receives the emitting light 118 and the second emitting light surface 128 emits the received emitting light 118. In one embodiment, the diffuser assembly 124 is, for example, either a diffusion sheet or a diffusion plate.

As shown in the candle power distribution C3 of FIG. 5, an emitting angle “AN” at 0 degrees to 60 degrees have a wide range of luminous intensity (light intensity IN) along 0 to 180 degrees (C0-C180) of the symmetrical bat-wing candle power distribution C3. In other words, the candle power distribution C3 forms a light shape of a bat-wing candle power distribution so that the light is concentrated in the lower left position and the lower right position of the prism sheet 102. In FIG. 5, a candle power distribution C4 is a candle power distribution along 90 degrees to 270 degrees (C90-C270). In the bat-wing candle power distribution of the present invention, the emitting light 118 within the illuminance area 122 of the reflection structure 104 forms a uniform illuminance distribution. As shown in FIG. 5, the shape of the bat-wing candle power distribution C3 are more rounded, and uniformly distributed and centralized.

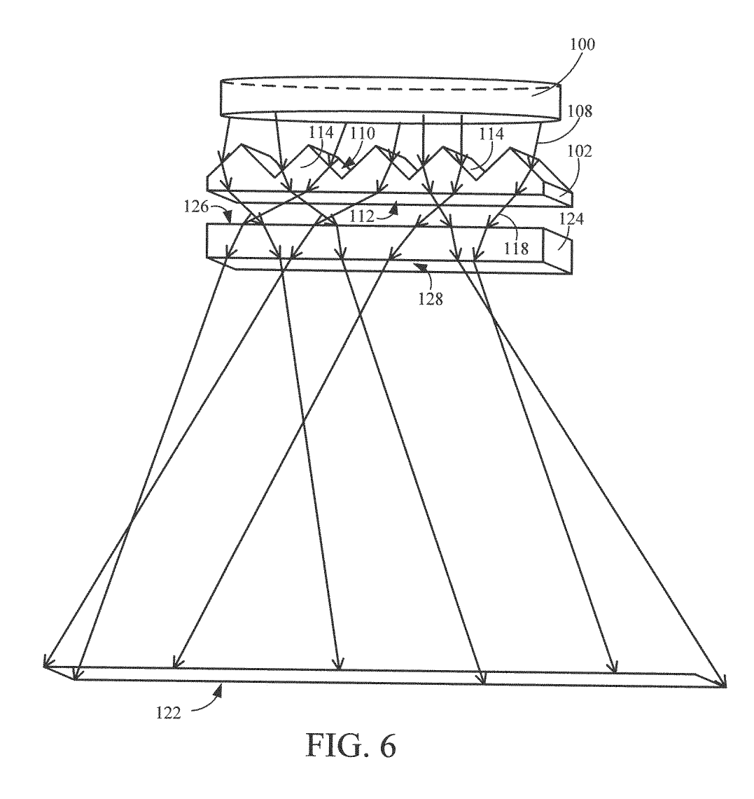

FIG. 6 is an illustrative three-dimensional view of a projection light source structure having a bat-wing candle power distribution according to a third embodiment of the present invention. The candle power distribution with the bat-wing candle power distribution of a projection light source structure in the third embodiment is similar to the candle power distribution with the bat-wing candle power distribution of a projection light source structure in the second embodiment. The difference is that a reflection structure is removed in the projection light source structure of the third embodiment omits. In the third embodiment, the projection light source structure having a bat-wing candle power distribution includes at least one light-emitting diode light source 100, the prism sheet 102 and a diffuser assembly 124, to save the manufacturing cost of the projection light source structure by omitting the reflection structure 104.

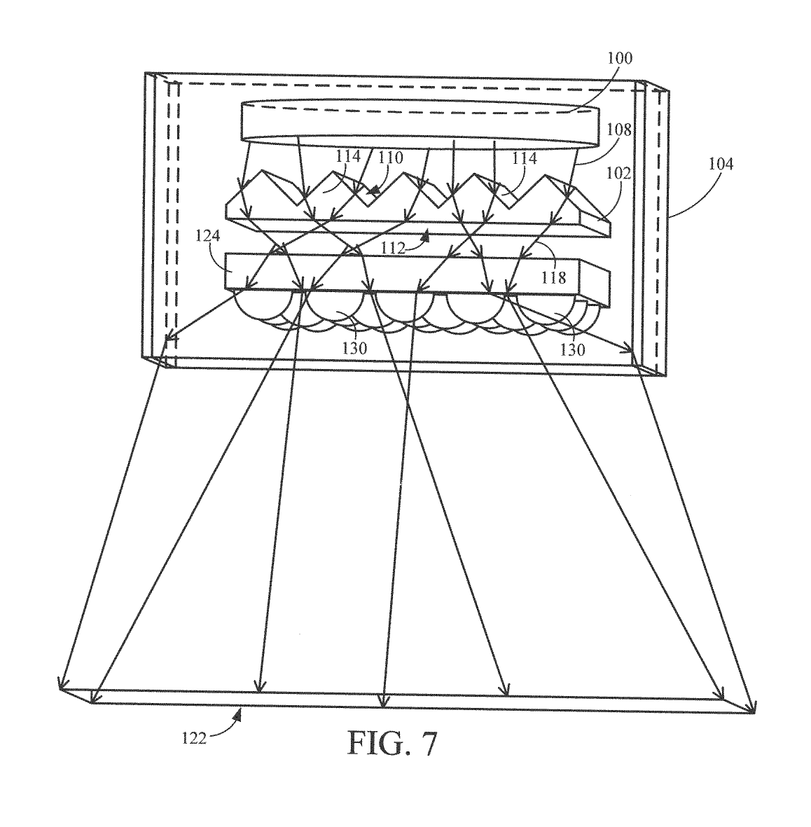

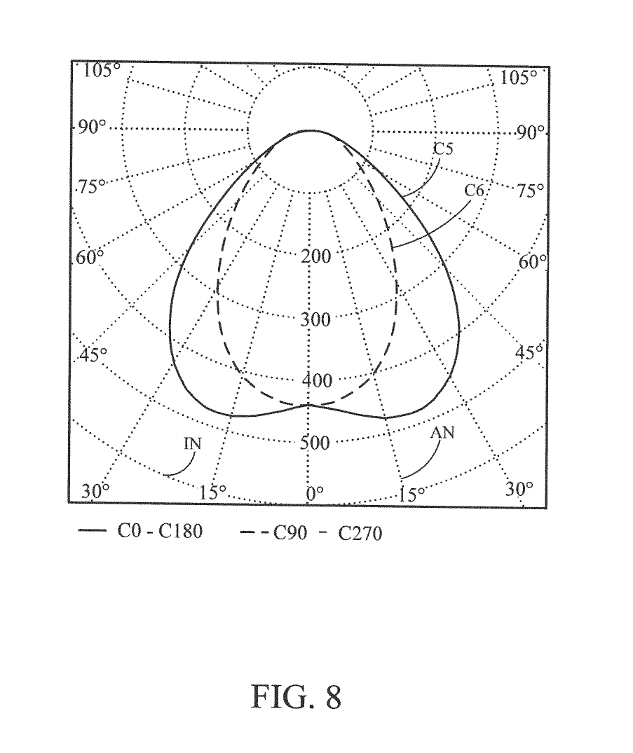

FIG. 7 is an illustrative three-dimensional view of a projection light source structure having a bat-wing candle power distribution according to a fourth embodiment of the present invention. FIG. 8 is an illustrative waveform view of the bat-wing candle power distribution in FIG. 7 according to the fourth embodiment of the present invention. The candle power distribution with the bat-wing candle power distribution of a projection light source structure in the fourth embodiment is similar to the candle power distribution with the bat-wing candle power distribution of a projection light source structure in the second embodiment. The difference is that the second light emitting surface 128 of the diffuser assembly 124 in the fourth embodiment includes a plurality of micro-lens structures 130. In one embodiment, each of the micro-lens structures 130 is selected from one group consisting of a micro convex lens structure, a micro concave lens structure, and the combination. As shown in FIG. 7, the micro-lens structure is a micro convex lens structure 130 to make the bat-wing candle power distribution more rounded. In one embodiment, the material of the diffuser assembly 124 is selected from one group consisting of poly ethylene terephthalate (PET), polyurethane (PU), polycarbonate (PC), polypropylene (PP), polymethyl methacrylate (PMMA), glass and silicon material. In one embodiment, the second light incident surface 126 and the second light emitting surface 128 opposite to the second light incident surface 126 of the diffuser assembly 124 is a transparent surface or opaque surface. In another example of the fourth embodiment, the projection light source structure having the bat-wing candle power distribution of only includes at least one light-emitting diode light source 100, the prism sheet 102 and a diffuser assembly 124 having a plurality of micro-lens structures 130, to save the manufacturing cost of the projection light source structure by omitting the reflection structure 104.

As shown in the candle power distribution C5 of FIG. 8, an emitting angle “AN” at 0 degrees to 60 degrees have a wide range of luminous intensity (light intensity IN) along 0 to 180 degrees (C0-C180) of the symmetrical bat-wing candle power distribution C5. In other words, the candle power distribution C5 forms a light shape of a bat-wing candle power distribution so that the light is concentrated in the lower left position and the lower right position of the prism sheet 102. In FIG. 8, a candle power distribution C6 is a candle power distribution along 90 degrees to 270 degrees (C90-C270). In the bat-wing candle power distribution of the present invention, the emitting light 118 within the reflection structure 104 forms a uniform illuminance distribution. As shown in FIG. 8, the shape of the bat-wing candle power distribution C5 are more rounded, and uniformly distributed and centralized.

According to the above-mentioned descriptions, the projection light source structure having a bat-wing candle power distribution utilizes a prism sheet and/or a diffuser assembly, to control the LED light source to form a bat-wing candle power distributions of uniform emitting light so that the emitting light to form a predetermined shape of the illuminance area by using the reflection structure. A lamp (e.g., a desk lamp) of the present invention to project the light on the surface to form different shaped illuminance regions, which reaches uniformity, brightness and illuminance uniformity, and can improve the quality of the lamp.

As is understood by a person skilled in the art, the foregoing preferred embodiments of the present invention are illustrative rather than limiting of the present invention. It is intended that they cover various modifications and similar arrangements be included within the spirit and scope of the present invention, the scope of which should be accorded the broadest interpretation so as to encompass all such modifications and similar structures.

What is claimed is:

1. A projection light source structure having a bat-wing candle power distribution, comprising:
at least one light-emitting diode (LED) light source disposed on a substrate to form a light; and
a prism sheet having a first light incident surface and a first light emitting surface opposite to the first light incident surface, wherein the first light incident surface is directed to the at least one light-emitting diode light source, a plurality of prismatic structures is distributed on the first light incident surface to guide the light for projecting the light from the first light incident surface to the first light emitting surface to form the bat-wing candle power distribution having an emitting light.

2. The projection light source structure having the bat-wing candle power distribution of claim 1, wherein the at least one LED light source comprises either an organic light-emitting diode (OLED) or a polymer light-emitting diodes (PLED).

3. The projection light source structure having the bat-wing candle power distribution of claim 1, wherein the at least one LED light source comprises a plurality of LED light sources.

4. The projection light source structure having the bat-wing candle power distribution of claim 1, wherein the first light emitting surface of the prism sheet is a planar structure.

5. The projection light source structure having the bat-wing candle power distribution of claim 1, wherein a material of the prism sheet is selected from one group consisting of poly ethylene terephthalate (PET), polyurethane (PU), polycarbonate (PC), polypropylene (PP), polymethyl methacrylate (PMMA), glass and silicon material.

6. The projection light source structure having the bat-wing candle power distribution of claim 1, further comprising a diffuser assembly adjacent to the prism sheet, wherein the prism sheet is disposed between the at least one LED light source and the diffuser assembly to diffuse the emitting light of the bat-wing candle power distributions to form a uniform emitting light.

7. The projection light source structure having the bat-wing candle power distribution of claim 6, wherein the diffuser assembly comprises a second light incident surface and a second light emitting surface opposite to the second light incident surface, and the second light incident surface is configured to receive the emitting light and the second emitting light surface emits the received emitting light.

8. The projection light source structure having the bat-wing candle power distribution of claim 7, wherein the diffuser assembly is either a diffusion sheet or a diffusion plate.

9. The projection light source structure having the bat-wing candle power distribution of claim 7, wherein the second light emitting surface of the diffuser assembly comprises a plurality of micro-lens structures.

10. The projection light source structure having the bat-wing candle power distribution of claim 9, wherein each of the micro-lens structures is selected from one group consisting of a micro convex lens structure, a micro concave lens structure, and the combination.

11. The projection light source structure having the bat-wing candle power distribution of claim 1, further comprising a reflection structure, wherein the reflection structure is disposed in a peripheral region of the at least one light-emitting diode light source and the prism sheet, so that the emitting light to form a predetermined shape of an illuminance area.

12. The projection light source structure having the bat-wing candle power distribution of claim 11, wherein a shape of the reflection structure is selected from one group consisting of a square shape, a rectangular shape, an oval shape, a polygon shape, and an irregular shape.

13. The projection light source structure having the bat-wing candle power distribution of claim 12, wherein a length-to-width ratio of the rectangular shape is selected from one group consisting of 2:1, 4:3 and 16:9.

14. A projection light source structure having a bat-wing candle power distribution, comprising:
at least one light-emitting diode (LED) light source disposed on a substrate to form a light;
a prism sheet having a first light incident surface and a first light emitting surface opposite to the first light incident surface, wherein the first light incident surface is directed to the at least one light-emitting diode light source, a plurality of prismatic structures is distributed on the first light incident surface to guide the light for projecting the light from the first light incident surface to the first light emitting surface to form the bat-wing candle power distribution having an emitting light; and
a diffuser assembly adjacent to the prism sheet, wherein the prism sheet is disposed between the at least one LED light source and the diffuser assembly to diffuse the emitting light of the bat-wing candle power distributions to form a uniform emitting light.

15. The projection light source structure having the bat-wing candle power distribution of claim 14, wherein the at least one LED light source comprises either an organic light-emitting diode (OLED) or a polymer light-emitting diodes (PLED).

16. The projection light source structure having the bat-wing candle power distribution of claim 14, wherein the at least one LED light source comprises a plurality of LED light sources.

17. The projection light source structure having the bat-wing candle power distribution of claim 14, wherein the first light emitting surface of the prism sheet is a planar structure.

18. The projection light source structure having the bat-wing candle power distribution of claim 14, wherein a material of the prism sheet is selected from one group consisting of poly ethylene terephthalate (PET), polyurethane (PU), polycarbonate (PC), polypropylene (PP), polymethyl methacrylate (PMMA), glass and silicon material.

19. The projection light source structure having the bat-wing candle power distribution of claim 14, wherein the diffuser assembly comprises a second light incident surface and a second light emitting surface opposite to the second light incident surface, and the second light incident surface is configured to receive the emitting light and the second emitting light surface emits the received emitting light.

20. The projection light source structure having the bat-wing candle power distribution of claim 19, wherein the diffuser assembly is either a diffusion sheet or a diffusion plate.

21. The projection light source structure having the bat-wing candle power distribution of claim 19, wherein the second light emitting surface of the diffuser assembly comprises a plurality of micro-lens structures.

22. The projection light source structure having the bat-wing candle power distribution of claim 21, wherein each of the micro-lens structures is selected from one group consisting of a micro convex lens structure, a micro concave lens structure, and the combination.

23. The projection light source structure having the bat-wing candle power distribution of claim 14, further comprising a reflection structure, wherein the reflection structure is disposed in a peripheral region of the at least one light-emitting diode light source and the prism sheet, so that the emitting light to form a predetermined shape of an illuminance area.

24. The projection light source structure having the bat-wing candle power distribution of claim 23, wherein a shape of the reflection structure is selected from one group consisting of a square shape, a rectangular shape, an oval shape, a polygon shape, and an irregular shape.

25. The projection light source structure having the bat-wing candle power distribution of claim 24, wherein a length-to-width ratio of the rectangular shape is selected from one group consisting of 2:1, 4:3 and 16:9.
